(19) United States
(12) Patent Application Publication
(10) Pub. No.: US 2005/0006978 A1
(43) Pub. Date: Jan. 13, 2005

(54) Twin coil claw pole rotor with stator phase shifting for electrical machine

(76) Inventor: Michael D. Bradfield, Anderson, IN (US)

Correspondence Address: James J. Merrick;Cantor Colburn LLP, 55 Griffin Road South, Bloomfield, CT, 06002, US

(21) Appl. No.: 10/713,581

(22) Filed: Nov. 14, 2003

Related U.S. Application Data
(60) Provisional application No. 60/485,610, filed on Jul. 7, 2003.

(51) Int. Cl. H02K 1/22

(52) U.S. Cl. 310/263

(57) ABSTRACT

A dynamoelectric machine including a rotor composed of more than two flux carrying segments, each segment having P/2 claw poles, where P is an even number; and includes n independent sets of three-phase stator windings inserted in a plurality of slots defining a stator, each set of three-phase windings shifted from each other by π/(3n) radians, wherein n is a positive integer greater than 1.

### CROSS REFERENCE TO RELATED APPLICATION

This application claims the benefit of U.S. Provisional Application No. 60/485,610, filed Jul. 7, 2003 the contents of which are incorporated by reference herein in their entirety.

### TECHNICAL FIELD

This application relates generally to an electrical apparatus. More specifically, this application relates to a twin coil rotor for an electrical machine and enhancing output and efficiency of the same. The application also relates to a twin coil rotor for an electrical machine and a system and method to reduce emitted noise, particularly magnetic noise.

### BACKGROUND

Electrical loads for vehicles continue to escalate. At the same time, the overall package size available for the electrical generator continues to shrink. Consequently there is a need for a higher power density system and method of generating on-board electricity.

In addition, it is desired to reduce the underhood noise associated with a three-phase alternating current (AC) produced by an alternator. The three-phase alternating current is rectified into a direct current, which can be stored in a battery of a vehicle or be used directly by the electrical circuit of the vehicle which is supplied with a direct current (DC) voltage. In particular, it is desired to reduce the magnetic noise.

### BRIEF SUMMARY OF THE INVENTION

The above discussed and other drawbacks and deficiencies are overcome or alleviated by a dynamoelectric machine including a rotor composed of more than two flux carrying segments, each segment having P/2 claw poles, where P is an even number; and includes n independent sets of three-phase stator windings inserted in a plurality of slots defining a stator, each set of three-phase windings shifted from each other by π/(3n) radians, wherein n is a positive integer greater than 1.

In an exemplary embodiment when n=2, the stator includes two sets of three-phase windings each connected to a corresponding three-phase rectifier, each of the two sets of stator windings are shifted by 30 electrical degrees relative to each other, and the stator is defined by 3nP or 72 slots. The rotor is a twelve pole, claw pole rotor having three segments.

### BRIEF DESCRIPTION OF THE DRAWINGS

FIG. 1 is a sectional view of an AC generator incorporating a stator assembly and a twin coil three segment claw pole rotor assembly constructed in accordance with the present invention;

FIG. 2 is a perspective view of the rotor assembly of FIG. 1;

FIG. 3 is a circuit diagram of an exemplary embodiment of a stator assembly of FIG. 1 having two sets of three-phase stator windings each set in operable communication with a corresponding three-phase bridge rectifier and with the twin rotor assembly;

FIG. 4 is a partial plan view of a seventy-two slot stator in operable communication with the three segments of the rotor assembly in accordance with the invention;

FIG. 5 is a graph illustrating the two three-phase stator windings of FIG. 3 being shifted by thirty electrical degrees from each other; and

FIGS. 6 and 7 schematically illustrate the respective two three-phase stator windings graphically illustrated in FIG. 5.

### DESCRIPTION OF THE PREFERRED EMBODIMENT

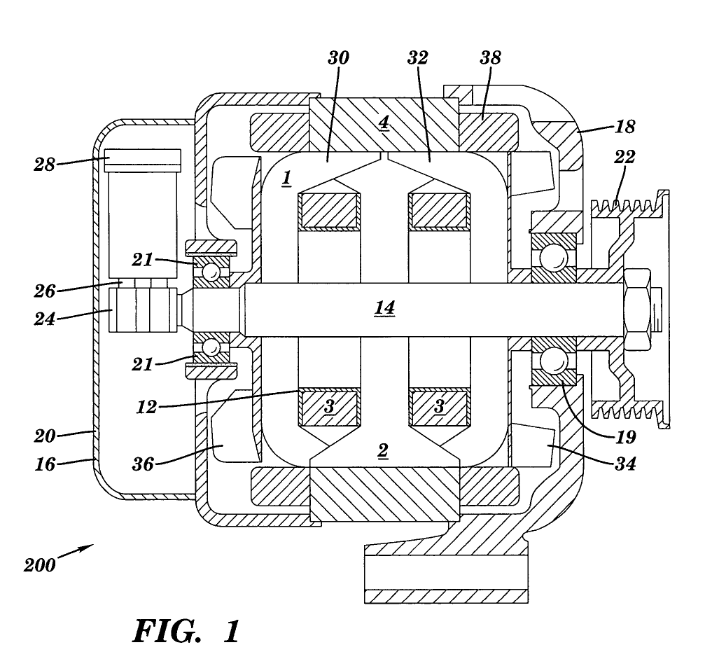

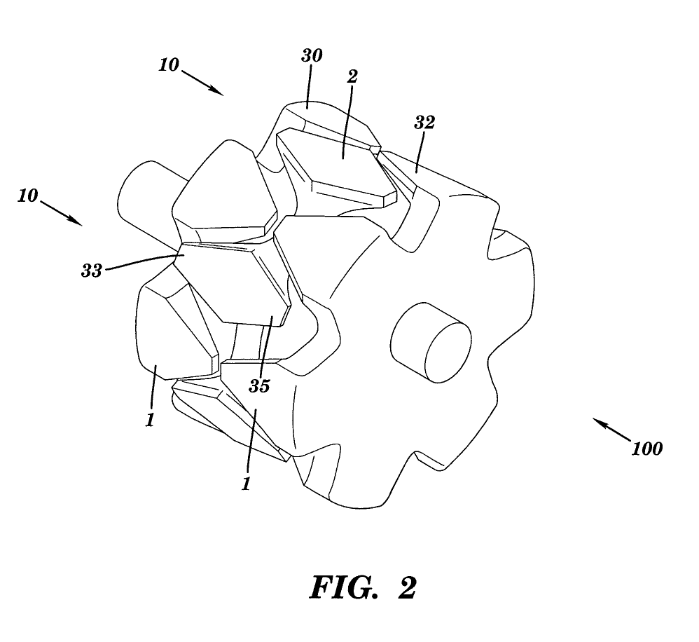

Referring to FIGS. 1 and 2, an exemplary embodiment of a rotor assembly 100 having three claw pole segments is illustrated. The two outbound claw pole segments, or end segments 1, are aligned with each other such that they point towards each other and define a width of the rotor assembly 100. Each end segment 1 has P/2 claw poles where P is an even number and representative of the total number of poles. A third, and center claw pole segment 2 is disposed intermediate end segments 1. Center claw pole segment 2 has poles that project toward the outbound claw pole segments 1 and is typically symmetrical about its center. More specifically, each pole of center claw pole segment 2 extends between a gap 10 created between contiguous claw poles of each end segment 1. Center claw pole segment 2 also has P/2 claw poles where P is an even number corresponding to P for the number of P/2 claw poles of each end segment 1. It will be noted that outbound end claw pole segments 1 are disposed on an outer circumferential edge at a uniform angular pitch in a circumferential direction so as to project axially, and each of the opposing claw pole segments 1 are fixed to shaft 14 facing each other such that the end segment claw-shaped magnetic poles would intersect if they were extended. Furthermore, center claw pole segment 2 is disposed in gap 10 defined by contiguous segments 1 such that a pair of opposing first and second claw-shaped magnetic poles 33 and 35 extending axially defining a circumferential periphery of each center pole segment intermesh with claw-shaped magnetic poles 30 and 32 defining end segments 1.

A field coil winding 3 is located between each end pole segment 1 on a corresponding bobbin 12 for a total of two field coil windings 3. The field coil windings 3 are energized such that the magnetic polarity of the outbound or end pole segments 1 are the same and opposite the center pole segment 2. Such an arrangement for the field rotor produces a stronger rotating magnetic field and allows the axial length of a stator 4 to be more effectively lengthened compared to a claw pole Lundell alternator. It will be recognized by one skilled in the pertinent art that permanent magnets can be placed between the claw pole segments 1, 2 to further enhance output and efficiency of the stator 4 and rotor assembly 100.

Referring now to FIG. 1, rotor assembly 100 is disposed in a dynamoelectric machine 200 that operates as an alternator in an exemplary embodiment, but not limited thereto, and is constructed by rotatably mounting a claw pole rotor or rotor assembly 100 by means of a shaft 14 inside a case 16 constituted by a front bracket 18 and a rear bracket 20 made of aluminum and fixing stator 4 to an inner wall surface of the case 16 so as to cover an outer circumferential side of the rotor assembly 100.

The shaft 14 is rotatably supported in the front bracket 18 via bearing 19 and the rear bracket 20 via bearing 21. A pulley 22 is fixed to a first end of this shaft 14, enabling rotational torque from an engine to be transmitted to the shaft 14 by means of a belt (not shown).

Slip rings 24 for supplying an electric current to the rotor assembly 100 are fixed to a second end portion of the shaft 14, a pair of brushes 26 being housed in a brush holder 28 disposed inside the case 16 so as to slide in contact with these slip rings 24. A voltage regulator (not shown) for adjusting the magnitude of an alternating voltage generated in the stator 4 is operably coupled with the brush holder 28.

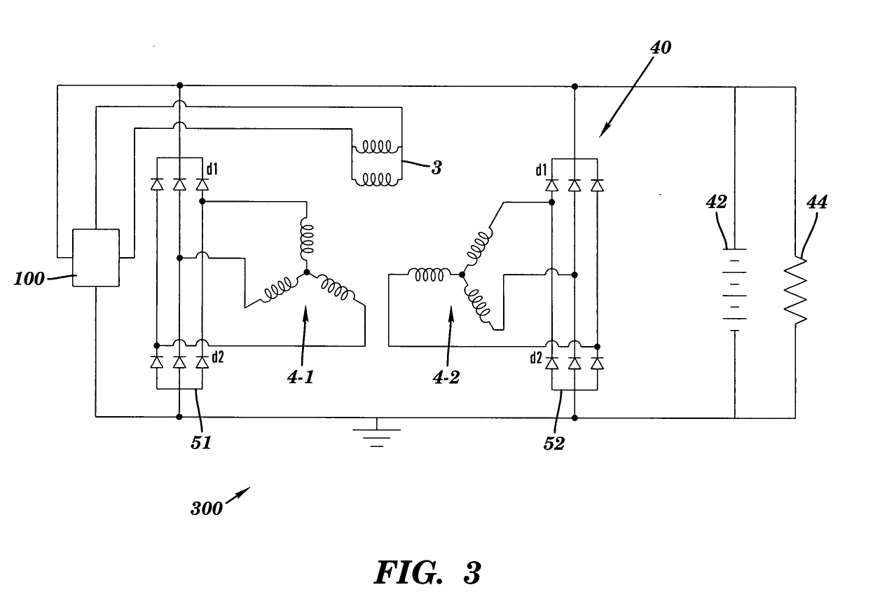

A rectifier (one of two generally indicated at 40) for converting alternating current generated in the stator 4 into direct current is mounted inside case 16, the rectifier 40 being constituted by a three-phase full-wave rectifier in which three diode pairs, respectively, are connected in parallel, each diode pair being composed of a positive-side diode d₁ and a negative-side diode d₂ connected in series (see FIG. 3). Output from the rectifier 40 can be supplied to a storage battery 42 and an electric load 44.

As described above, the rotor assembly 100 is constituted by: the pair of field windings 3 for generating a magnetic flux on passage of an electric current; and pole cores or segments 1 and 2 disposed so as to cover the field windings 3, magnetic poles being formed in the segments 1 and 2 by the magnetic flux generated by the field windings 3. The end and center segments 1 and 2, respectively, are preferably made of iron, each end segment 1 having two first and second claw-shaped magnetic poles 30 and 32, respectively, disposed on an outer circumferential edge and aligned with each other in a circumferential direction so as to project axially, and the end segment pole cores 30 and 32 are fixed to the shaft 14 facing each other such that the center segment core is therebetween the claw-shaped end segment magnetic poles 30 and 32 and intermesh with the magnetic poles 33 and 35 of center segment 2, respectively, as best seen in FIG. 2.

Still referring to FIG. 1, fans 34 and 36 (internal fans) are fixed to first and second axial ends of the rotor assembly 100. Front-end and rear-end air intake apertures (not shown) are disposed in axial end surfaces of the front bracket 18 and the rear bracket 20, and front-end and rear-end air discharge apertures (not shown) are disposed in first and second outer circumferential portions of the front bracket 18 and the rear bracket 20 preferably radially outside front-end and rear-end coil end groups of the armature winding 38 installed in the stator core 4.

In the dynamoelectric machine 200 constructed in this manner, an electric current is supplied to the twin field windings 3 from the storage battery through the brushes 26 and the slip rings 24, generating a magnetic flux. The first claw-shaped magnetic poles 30 and 32 of the end segments 1 are magnetized into a fixed polarity by this magnetic flux (such as North seeking (N) poles), and the center claw-shaped magnetic poles 33 and 35 are magnetized into the opposite polarity (such as South-seeking (S) poles). At the same time, rotational torque from the engine is transmitted to the shaft 14 by means of the belt (not shown) and the pulley 22, rotating the rotor assembly 100. Thus, a rotating magnetic field is imparted to the armature winding 38, inducing a voltage across the armature winding 38.

Referring now to FIG. 3, the dynamoelectric machine 200 is illustrated as a circuit diagram. This alternating-current electromotive force passes through a rectifier 40 and is converted into direct current, the magnitude thereof is adjusted by the voltage regulator (not shown), a storage battery 42 is charged, and the current is supplied to an electrical load 44.

Along with electrical load escalation, is a continuing trend of lower allowable underhood noise, particularly magnetic noise. To address this concern, stator 4 in accordance with an exemplary embodiment of the invention includes two sets of three-phase windings 4-1 and 4-2 that are each connected to an individual three-phase rectifier, 51 and 52, respectively.

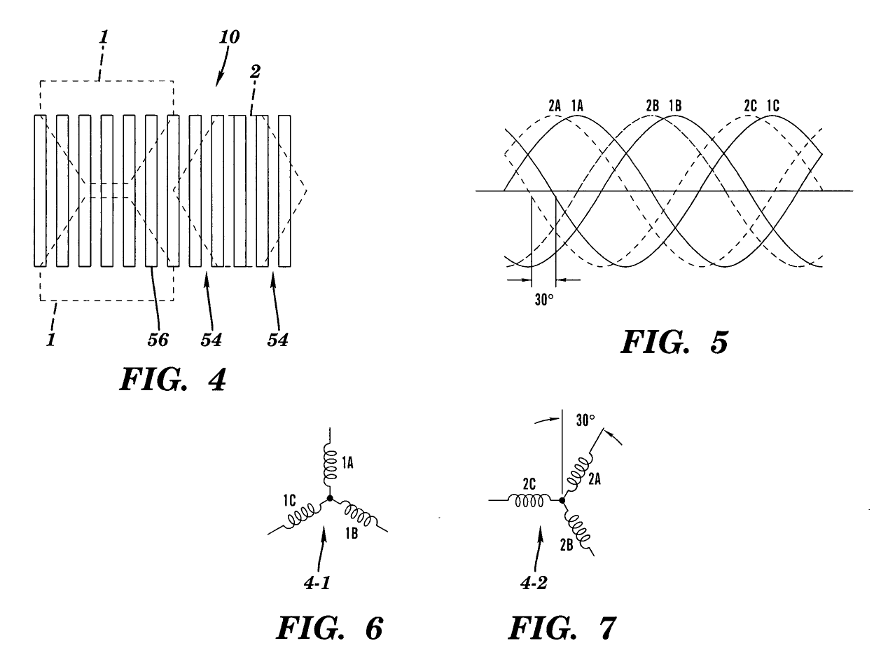

Referring to FIGS. 4-7, it will be recognized that the respective stator windings 4-1 and 4-2 are shifted by 30 electrical degrees relative to each other. For example, phase 1C of winding 4-1 is offset from phase 2C of winding 4-2 graphically illustrated in FIG. 5 and schematically shown in FIGS. 6 and 7. For a typical 12 pole rotor as illustrated in FIG. 2, this is accomplished by constructing stator 4 having 72 slots 54 defined by contiguous stator teeth 56 as best seen in FIG. 4. It will be recognized that a pair of opposing end segments 1 and center segment 2 are shown in phantom as positionally oriented with respect to stator teeth 56 and relative to each other, wherein each center segment 2 is intermediate a pair of opposing end segments 1.

Each set of three-phase stator windings 4-1 and 4-2 is inserted such that conductors from each of the three-phases (i.e., 1A, 1B, and 1C or 2A, 2B, and 3C) are spaced 6 slots 54 apart, or 180 electrical degrees. However, the two three-phase winding sets 4-1 and 4-2 are spaced apart from each other by one stator slot 54 which is 5 mechanical degrees (i.e., 360°/72 slots) or 30 electrical degrees. This electrical shifting of the stator output eliminates the harmonic content that produces the most undesirable magnetic noise.

Although the idea is to use two sets of three-phase windings 4-1 and 4-2, the above disclosed concept can be extended to n sets of three-phase windings where n is a positive integer greater than 1. With such a combination, the stator 4 consists of 3nP slots and the windings 4-1, 4-2 . . . 4-n are shifted from each other by an electrical angle of π/(3n) radians. The predetermined number of field poles is a positive integer n greater than 1, while the predetermined number of slots is 3nP, reducing spatial magnetomotive higher harmonics, thereby enabling electromagnetic noise to be reduced. For example, when n=2 representative of the number of sets of windings 4-1 and 4-2, and the number of poles (P)=12, the total number of slots 54 is 72 or 3×(2)×(12)=72. Furthermore, each of the n sets of three-phase windings is connected to a separate three-phase rectifier 51 or 52. In this example, it can be seen that when n=2 independent sets of three-phase stator windings 4-1 and 4-2 inserted in the stator, each winding 4-1, 4-2 are shifted from each other by π/(3n) radians or π/(3×2)=π/6=30°.

Thus, having a field rotor composed of more than two flux carrying segments with each segment having P/2 claw poles where P is an even number and n independent sets of three-phase stator windings inserted in the stator such that they are shifted from each other by π/(3n) radians into one common electrical machine, higher outputs, higher efficiency and lower magnetic noise result. Accordingly, the technical benefits realized by inserting at least two independent sets of three-phase windings in the stator in conjunction with a three or more claw pole rotor is that it significantly increases output and efficiency capability and at the same time significantly reduces magnetic noise in a very cost effective manner.

While the exemplary twin coil claw pole rotor and stator phase shifting has been described for use with generators associated with vehicles, the same may also be used and incorporated in applications other than generators for a vehicle where enhancement in electrical generation efficiency and reduction of magnetic noise is desired.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A dynamoelectric machine comprising:
a rotor composed of more than two flux carrying segments, each segment having P/2 claw poles, wherein P is an even number; and
n independent sets of three phase stator windings inserted in a plurality of slots defining a stator, each set of three-phase windings shifted from each other by π/(3n) radians.

2. The machine of claim 1, said each set of three-phase windings is operably connected to a corresponding three-phase rectifier.

3. The machine of claim 1, wherein a coil winding is disposed intermediate each of said more tan two flux carrying segments.

4. The machine of claim 3, wherein each coil winding is energized providing a first magnetic polarity on outbound claw poles defining said rotor and a second polarity opposite said first polarity on claw poles intermediate said outbound claw poles.

5. The machine of claim 1, wherein permanent magnets are disposed between said each segment to enhance at least one of output and efficiency.

6. The machine of claim 1, wherein n is a positive integer greater than 1.

7. The machine of claim 1, wherein said plurality of slots is defined by 3nP.

8. The machine of claim 1, wherein when n=2, said stator includes two sets of three-phase windings each connected to a corresponding three-phase rectifier, each of the two sets of stator windings are shifted by 30 electrical degrees relative to each other, and said stator is defined by 72 slots.

9. The machine of claim 8, wherein said rotor includes at least one of a 12 pole rotor where P=12 and a claw pole rotor having three segments.

10. The machine of claim 8, wherein said each of the two sets of stator windings is inserted such that each phase is spaced six slots apart from contiguous phases of said each of the two sets of stator windings.

11. An alternating current (AC) generator for a motor vehicle comprising:
a field rotor composed of more than two flux carrying segments, each segment having P12 claw poles, wherein P is an even number; and
n independent sets of three-phase stator windings inserted in a plurality of slots defining a stator, each set of three-phase windings shifted from each other by π/(3n) radians.

12. The generator of claim 11, wherein said each set of three-phase windings is operably connected to a corresponding three-phase rectifier.

13. The generator of claim 11, wherein a field coil winding is disposed intermediate each of said more than two flux carrying segments.

14. The generator of claim 13, wherein each field coil winding is energized providing a first magnetic polarity on outbound claw poles defining said field rotor and a second polarity opposite said first polarity on claw poles intermediate said outbound claw poles.

15. The generator of claim 11, wherein permanent magnets are disposed between said each segment to enhance at least one of output and efficiency.

16. The generator of claim 11, wherein n is a positive integer greater than 1.

17. The generator of claim 11, wherein said plurality of slots is defined by 3nP.

18. The generator of claim 11, wherein when n=2, said stator includes two sets of three-phase windings each connected to a corresponding three-phase rectifier, each of the two sets of stator windings are shifted by 30 electrical degrees relative to each other, and said stator is defined by 72 slots.

19. The generator of claim 18, wherein said field rotor includes at least one of a 12 pole rotor where P=12 and configured as a claw pole rotor having three segments.

20. The generator of claim 18, wherein said each of the two sets of stator windings is inserted such that each phase is spaced six slots apart from contiguous phases of said each of the two sets of stator windings.
